(19) United States
(12) Patent Application Publication
(10) Pub. No.: US 2025/0307898 A1
(43) Pub. Date: Oct. 2, 2025

(54) SYSTEMS AND METHODS FOR VEHICLE RECOMMENDATION

(71) Applicant: Cox Automotive, Inc., Atlanta, GA (US)

(72) Inventors: Ho Joon Sung, Johns Creek, GA (US); Samuel Henry Longenbach, Williston, VT (US); Anders Christen Solberg, South Burlington, VT (US)

(21) Appl. No.: 18/621,514

(22) Filed: Mar. 29, 2024

(51) Int. Cl. G06Q 30/0601

(52) U.S. Cl. CPC G06Q 30/0631

(57) ABSTRACT

The present disclosure is generally directed to recommending vehicles to a user. a method for recommending vehicle groups includes receiving browsing history of a user. The browsing history includes vehicle click data of the user. The method further includes determining one or more input vehicle groups based on one or more vehicle IDs of the vehicle click data, providing the one or more input vehicle groups to a ML model, and receiving, from the ML model, rankings of one or more predicted vehicle groups based on similarities of the one or more predicted vehicle groups to the one or more input vehicle groups.

### BACKGROUND

Consumers buying vehicles has evolved over the years. To buy a car, customers visit a dealership and physically browse all available cars on the dealership lot. In addition, consumers may browse available cars on the internet. For example, many dealerships offer their inventory online for customers to view. Websites have also been developed to provide a wide range of available cars from many different sellers. These websites include a large database of available vehicles that pulls from multiple catalogs. Customers visit these websites and can search by make, model, or other features to find a car that fits their needs. However, many different cars exist that are related, and a customer often has a hard time finding related cars while shopping. Websites lack an efficient way to present similar cars that customers may be interested in purchasing.

### BRIEF DESCRIPTION OF THE DRAWINGS

The accompanying drawings, which are incorporated in and constitute a part of this disclosure, illustrate various embodiments of the present disclosure. In the drawings:

FIG. 1 illustrates an example environment of a vehicle recommendation system.

FIG. 2 illustrates an example embodiment of the vehicle recommendation system of FIG. 1.

FIG. 3 illustrates an example flow diagram to generate vehicle recommendations using the vehicle recommendation system of FIG. 1.

FIG. 4 illustrates example demographic data and inventory data of FIG. 3.

FIG. 5 illustrates an example method for using a model to rank predicted vehicle groups.

FIG. 6 illustrates an example method that includes additional example operations for the method of FIG. 5.

FIG. 7 illustrates an example method for training a model of a vehicle recommendation system.

FIG. 8 illustrates an example computing device for performing one or more of the described operations.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The present disclosure is generally directed to a vehicle recommendation system for providing vehicle suggestions to users that are searching for a vehicle. Current systems look at customer data to determine a potential car. Further, industry classification of the year, make, and model is broad and results in grouping of vehicles that are not similar. The described vehicle recommendation system generates vehicle groups using mathematical relationships based on defined vehicle attributes. The vehicle groups are then labeled with a vehicle group identifier (ID) (sometimes referred to a “Vehicle Similarity Matrix ID” or “vehicle group”). After grouping, the vehicle recommendation system provides the vehicle group IDs to a model as training data. The model calculates and learns similarities between the vehicle group IDs. A user's data that includes past vehicle click data with one or more viewed vehicles is used as input to the model. From the learned similarities, the model is trained to produce vehicle group that are similar to the vehicle group IDs within the user's data. The similarity of the vehicle groups indicates a probability that the user will next select a vehicle from the provided vehicle group to view. Accordingly, the model predicts the next vehicle the user is likely to click or show interest. The vehicle recommendation system provides this prediction to the user as a suggested vehicle.

Vehicle groups are created such that variance between the vehicle groups (variance of the hypothetical mean or VHM) and the variance within the groups (expected value of process variance or EVPV) is balanced such that groups can be easily identified. This configuration of the groups enables the vehicle recommendation system to determine which vehicles best fit in each group and how the groups relate to one another. The vehicle groups can be calculated based on one or more vehicle attributes. The selected vehicle attributes are used in segmenting a catalog of vehicles into the vehicle groups. The vehicle group IDs are also associated with the vehicle groups. In addition to inputs for the model, the vehicle recommendation system uses the vehicle groups for expanding the recommendations. Further, additional data may also be used to tailor the recommendations.

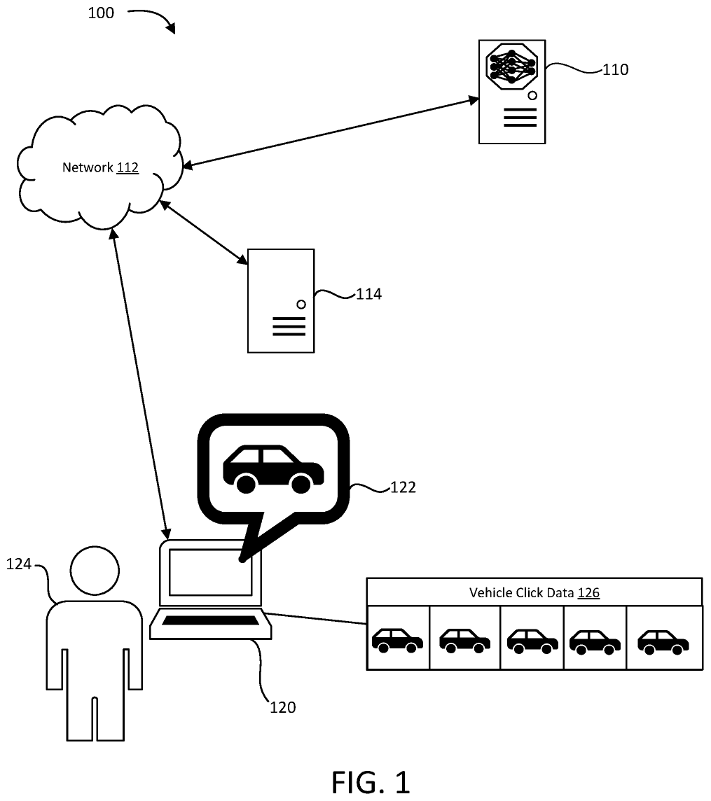

FIG. 1 illustrates an example environment 100 of a vehicle recommendation system 110. In the shown embodiment, the environment 100 includes the vehicle recommendation system 110 that connects through a network 112 to a computing device 120 and the website server 114. The computing device 120 displays a vehicle 122 to a user 124. In addition, the computing device 120 includes vehicle click data 126.

In the shown embodiment, the vehicle recommendation system 110 includes machine learning (ML) components for analyzing user browsing history to produce predicted vehicle group IDs. The vehicle recommendation system 110 sends the vehicle group IDs through the network 112 to the computing device 120. The sent recommendation may take the form of an email, a pop-up, or a next item in a list of vehicles that are displayed to the user 124. In some embodiments, the vehicle recommendation system 110 collects a large amount of user browsing data to train the ML model. Further, the vehicle recommendation system 110 may include additional models for generating the vehicle group IDs. The vehicle recommendation system 110 may also include separate models for analyzing consumer demographic and ownership data to enhance the provided recommendations or provide recommendations when no online shopping activity is available; this is also referred to as the persistent data models. Analyzing the user demographic and ownership data reveals patterns in consumer buying activity.

The computing device 120 displays a vehicle 122 to the user 124. In some embodiments, the vehicle 122 is shown on a webpage of a car buying website. The website may store vehicle click data 126 of the user 124. The vehicle click data 126 records the previously viewed vehicles by the user. In some embodiments, the vehicle click data 126 includes a user ID, a user household ID, a visit time, a vehicle ID, or a vehicle group ID. Further, the vehicle click data 126 stores the viewed vehicles according to how recently they were viewed. In some embodiments, the vehicle click data 126 is associated with a user ID or household ID that is stored as a cookie on the computing device 120. In some embodiments, the vehicle click data is stored on the website server 114 or is stored within the vehicle recommendation system 110. Other embodiments, include having the vehicle click data 126 stored on the computing device 120. In some embodiments, vehicle click data 126 includes a vehicle detail page, vehicle ID, and a time the user accessed a vehicle webpage including an associated vehicle.

In some embodiments, the website server 114 hosts a website of a vehicle dealership. The website server 114 maintains a catalog of vehicles that consumers, such as the user 124, can browse. To improve its recommendations, the website server 114 uses an API to access the vehicle recommendation system 110. The vehicle recommendation system 110 receives relevant data from the website server 114, such as the vehicle click data 126. After obtaining the relevant data, the vehicle recommendation system 110 provides predicted vehicle group IDs to the website server 114. In some embodiments, the vehicle recommendation system 110 matches the predicted vehicle group IDs to vehicles IDs associated with vehicles in the inventory of the vehicle dealership. Then, the vehicle recommendation system 110 sends the website server 114 a vehicle ID or vehicle to recommend to the user 124.

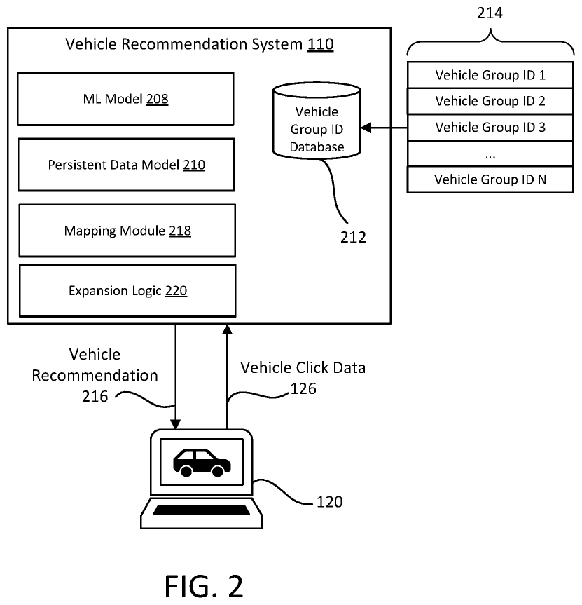

FIG. 2 illustrates an example embodiment of the vehicle recommendation system 110 of FIG. 1. In the shown embodiment, the vehicle recommendation system 110 includes a ML model 208, persistent data model 210, and a vehicle group database 212. The vehicle group database 212 includes a plurality of vehicle group IDs 214. The vehicle recommendation system 110 receives vehicle click data 126 and sends a vehicle recommendation 216 to the computing device 120. In some embodiments, the vehicle recommendation system 110 includes a mapping module 218.

Here, the ML model 208 is configured to receive vehicle group IDs from the vehicle click data 126, and predict a “next selected” group ID. In some embodiments, the mapping module 218 receives vehicle IDs and maps the vehicle IDs to vehicle group IDs of the plurality of vehicle group IDs 214. The mapped vehicle group IDs are then passed to the ML model 208. The “next selected” group ID is the vehicle group ID that is likely to be selected by the user 124 as they browse a vehicle catalog. In some embodiments, the ML model 208 is a bidirectional transformer architecture. The bidirectional transformer architecture is a type of encoder in a deep neural network to map input sequences to a series of continuous numerical representations. In addition, the bidirectional transformer architecture includes the ability to process information in both directions, which allows the models to capture contextual information from a sequence. This model further leverages self-attention, enabling it to analyze the relationships between all vehicle group IDs 214 used as input simultaneously. In some embodiments, bidirectional transformer model uses a “left-to-right model” and a “right-to-left model.” In some embodiments, received vehicle group IDs 214 from the vehicle group ID database 212 or the computing device 120 a to 128-dimensional numeric vector with help of 3 multi-head self-attention neural network layers and feed-forward layer. These neural network layers are designed to iteratively calculate similarity among VSM group IDs (i.e., 128 dimensional vectors). Further embodiments include optimizing the model using 6.2 million weights that are updated every 512 batches of sample sizes. The trained deep neural network is used to predict a vehicle or vehicle webpage that is most likely to be viewed next. The vehicle or vehicle webpage may be provided to the computing device 120 based on the user 124's historical web activities.

In some embodiments, the ML model 208 encodes one or more input vehicle groups into one or more numerical representations. The ML model 208 further determines the one or more predicted vehicle group IDs based on a calculated distance between the one or more input vehicle group IDs from the vehicle click data 126 and the one or more predicted vehicle group IDs. In some embodiments, the one or more input vehicle groups are vehicle group IDs 214. Further, determining the distance between the one or more input vehicle group IDs and the one or more predicted vehicle group IDs includes determining a distance between a numerical representation of the input vehicle group IDs of the vehicle click data 124 and a numerical representation of the predicted vehicle group IDs. The numerical representation may be a vector of varying lengths as previously described. The ML model 208 is also trained on the plurality of vehicle group IDs 214. The plurality of vehicle group IDs 214 are stored in the vehicle group ID database 212. In addition, the input vehicle groups IDs are obtained from the vehicle click data 126. In further embodiments, the ML model 208 is trained on user browser data.

The ML model 208 also ranks predicted vehicle group IDs. For example, the one or more predicted vehicle groups are ranked based on the similarities of the one or more predicted vehicle groups to the one or more input vehicle groups. In some embodiments, the similarities indicates a probability of the user 124 selecting a vehicle from the predicted vehicle group ID to view next. The similarities are measured based on calculated distance between the vector representations. In some embodiments, the first predicted vehicle group is determined based on a distance between a vector representation of the first predicted vehicle group and the input vehicle group, the distance calculated based on vehicle attributes. Further, adjusting the ML model 208 may include adjusting weights of the vehicle attributes. The closest vehicle group ID is then ranked first as a first predicted vehicle group ID. The vehicle recommendation system 110 provides a vehicle recommendation 216 to the computing device 120 of the user 124 including a recommended vehicle of the first predicted vehicle group ID. In some embodiments, the ML model 208 is adjusted based on the predicted vehicle group IDs. In some embodiments, the ML model 208 receives user demographic data to predict/determine a vehicle group ID.

In some embodiments, a second ranked vehicle group ID is used instead of the first ranked group ID. The persistent data models 210 determines recommendations based on other aspects such as demographics of a user of available inventory of a dealership when no online shopping activity is available. For example, this causes the vehicle recommendation system 110 to determine a second predicted vehicle group of one or more predicted vehicle groups, the second predicted vehicle group having a rank other than first of the one or more predicted vehicle groups. In some embodiments, the persistent data model 210 includes machine learning models that use demographic data and current ownership to reveal patterns in consumer buying activity. Further, the persistent data models 210 may include a deep neural network of 10 hidden layers with a rectified linear unit (ReLU) activation to extract relationships among different vehicle features and consumers. The persistent data models 210 is configured to use these relationships to predict a vehicle group ID that consumers with similar demographics will purchase. The data may be sourced from dealer websites, such as from the website server 114. Some embodiments include using a waterfall decision making framework to decide the vehicle recommendation 216 based on consumer data. Accordingly, the vehicle recommendation system 110 uses the persistent 210 to recommend vehicles or select a vehicle from a predicted vehicle group ID produced by ML model 208.

The persistent data model 210 uses user demographics data and inventory data to select a predicted vehicle group ID from the output of the ML model 208 or a vehicle from a selected vehicle group ID. For example, a predicted vehicle group is determined based on an inventory of available vehicles at a dealership. A dealership may only offer hybrids or gas-powered cars. A user may be selecting electric vehicles, which are recorded in vehicle click data 316. The dealership may wish to send a vehicle to the user of the users 310. Even though the dealership lacks electric vehicles, the vehicle recommendation system 110 can provide a vehicle from a relevant vehicle group, such as one with high miles per gallon or a hybrid vehicle, to the user since that group is similar to a vehicle group of electric vehicles.

The mapping module 218 maps receives vehicle click data 126 into one or more vehicle group IDs of the plurality of vehicle group IDs 214. These vehicle group IDs are used as input for the ML model 208. In some embodiments, the mapping module 218 maps a selected vehicle from a predicted vehicle group ID to provide as a vehicle recommendation 216.

The vehicle group ID database 212 stores the plurality of vehicle group IDs 214. The vehicle recommendation system 110 mathematically creates groups that represent different vehicles. In some embodiments, the plurality of vehicle group IDs 214 are created using vehicle attributes, which may include vehicle year, vehicle make, vehicle model, vehicle fuel type, vehicle truck cab size, vehicle body style, vehicle drive train, vehicle bed length, or the vehicle door style or door number. The fuel type may include electric, hybrid, or gas. The body style may include sedan or coup. The drive train may include four-wheel drive or two-wheel drive. In addition, the vehicle recommendation system 110 may use the ML model 208 to create the plurality of vehicle group IDs 214. In other embodiments, a different ML model, such as a K-means clustering model, is used to create the plurality of vehicle group IDs 214. In some embodiments, the plurality of vehicle group IDs 214 is predefined. In some embodiments, the vehicle recommendation 216 is an email, a pop-up, or a tab presenting the recommended vehicle on the computing device 120.

The expansion logic 220 further expands the list of relevant vehicle group IDs to the user 124 based on similarities between the predicted vehicle group IDs and to vehicle group IDs of the plurality of vehicle group IDs 214 that are sufficiently similar. For example, expanded vehicle group IDs may be within a predetermined distance that is calculated between an expanded vehicle group IDs and the predicted vehicle group IDs from the ML model 208. Expanding the list vehicle group IDs enables the vehicle recommendation system 110 to select a vehicle from a larger number of vehicle group IDs when recommending a vehicle. In some embodiments, the expansion logic 220 uses similarities of vehicle attributes to expand the number of vehicle group IDs based on the predicted vehicle group IDs from the ML model 208.

While shown as one system, the vehicle recommendation system may be implemented over several devices and/or systems. For example, some of the components may be located on separate devices.

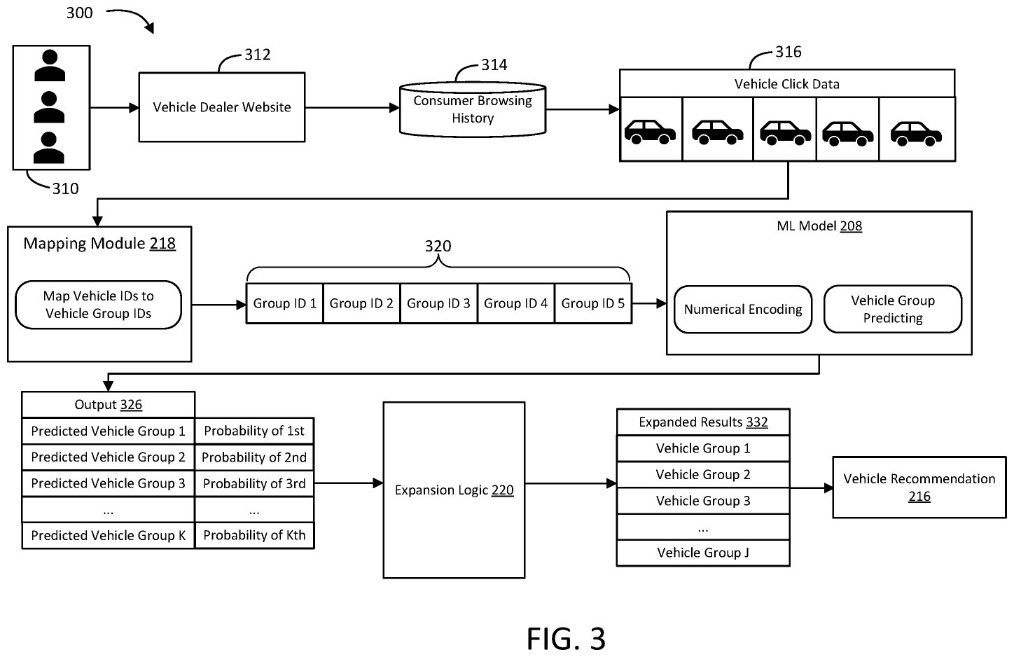

FIG. 3 illustrates an example flow diagram 300 to generate the vehicle recommendation 216 using components of vehicle recommendation system 110 of FIG. 1. Users 310 may access a vehicle dealer website 312. Consumer browsing history datastore captures and stores vehicle click data 316 when the users 310 access the vehicle dealer website 312. The vehicle click data is passed to the mapping module 218, which maps vehicle IDs within the vehicle click data to vehicle group IDs. This mapping generates the one or more vehicle group IDs 320. The vehicle recommendation system 110 provides the one or more vehicle group IDs 320 to the ML model 208. The ML model 208 performs numerical encoding and vehicle group predicting. The ML model 208 produces output 326. The output is fed to the expansion logic 220 for adjustment to produce expanded results 332. The vehicle recommendation system 110 then provides the vehicle recommendation 216.

In the shown environment, the flow diagram 300 illustrates an example of receiving input data and generating a vehicle recommendation 216. The users 310 may include user 124. Further, the users 310 may be part of the same house or user group based on a shared internet protocol (IP) address or other shared factors. Analyzing users 310 together as a group provides insight to their desired vehicle since they may require a larger vehicle depending on the number of users in the group of users 310.

As the users view vehicles on a vehicle dealer website 312, such as one hosted on website server 114, data is collected. The data may be collected by the website server 114, the vehicle recommendation system 110, or another entity. The consumer browsing history 314 is then obtained from the users 310 interaction with the vehicle dealer website 312. This process results in vehicle click data 316. In some embodiments, the vehicle click data 316 includes vehicle IDs. In some embodiments, these vehicle IDs are associated with a dealership catalog. The mapping module 218 maps the vehicle IDs of the vehicle click data 316 to vehicle group IDs. Mapping module 218 then produces one or more vehicle group IDs 320. The vehicle recommendation system inputs the one or more vehicle group IDs 320 to the ML model 208.

The ML model 208 first encodes the one or more vehicle group IDs 320 with numerical encoding. In some embodiments, each of the vehicle group IDs of the one or more vehicle group IDs 320 are encoded into a numerical vector. The ML model may receive 512 numerical vector representations for determining a predicted vehicle group ID. The ML model 208 then determines one or more predicted vehicle group IDs in output 326. These one or more predicted vehicle group IDs may be determined based on the one or more predicted vehicle group IDs distance to the one or more vehicle group IDs 320. The output 326 also includes a probability of each predicted vehicle group ID. The probability indicates the probability of a specific user of user 310 or any of the users 310 selecting a vehicle from the corresponding vehicle group ID. In some embodiments, the one or more predicted vehicle group IDs may include every vehicle group ID of the plurality of vehicle group IDs 214. The output 326 may include a listed probability for each vehicle group ID of the plurality of vehicle group IDs 214. Other embodiments list vehicle group IDs with a corresponding probability above a predetermined threshold. The output 326 includes predicted vehicle group IDs up to the predicted vehicle group K. Further, the one or more predicted vehicle group IDs are ranked based on their probability.

The vehicle recommendation system 110 then provides the output 326 including the one or more predicted vehicle group IDs to the expansion logic 220. The expansion logic 220 determines expanded vehicle group IDs. This includes calculating similarities between the predicted vehicle group IDs and the expanded vehicle group IDS. The expanded results 332 includes additional vehicle group IDs that increase the chances of a recommended vehicle being relevant to the user since more groups are provided. The expansion logic 220 then outputs expanded results 332, which are sent as a vehicle recommendation 216. In some embodiments, deduping is used to remove duplicate vehicle group IDs that may be introduced using the expansion logic 220 before providing the vehicle recommendation 216.

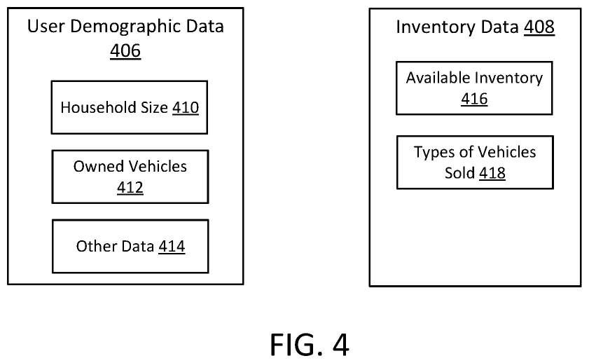

FIG. 4 illustrates example demographic data 406 and inventory data 330 of FIG. 3. In the shown embodiment, the user demographic data 328 includes household size 410, owned vehicles 412, and other data 414. The inventory data 330 includes available inventory 416 and types of vehicles sold 418. The user demographic data 406 can be used by the persistent data model 210 to predict a vehicle group ID or a vehicle that a user is likely to click next to view when no browsing history of the user is available. For instance, the household size 410 can be analyzed by the persistent data model 210 to determine that larger households prefer a sports utility vehicle (SUV). The persistent data model 210 may also reveal that a family with a newborn prefers a mini-van or vehicles with increased safety features. Other data 414 may include location data. The persistent data model 210 may determine from the location data that users in snowy areas do not purchase vehicles that are only two-wheel drive. In another example, the owned vehicles 412 shows the currently owned vehicle. If the user owns a truck, the persistent data model 210 may predict a truck will likely be their next click to view while shopping for cars. The inventory data 408 is used as previously described with the electric cars. Other data can include available inventory 416. For example, the vehicle recommendation system 110 determines that a dealership does not have a truck with a five feet bed, but determine the user is likely interested and will click on a truck with a six feet bed. The vehicle recommendation system 110 can use the user demographic data 406 and the inventory data 408 as input to the persistent data model to make other determinations for vehicle recommendations as well.

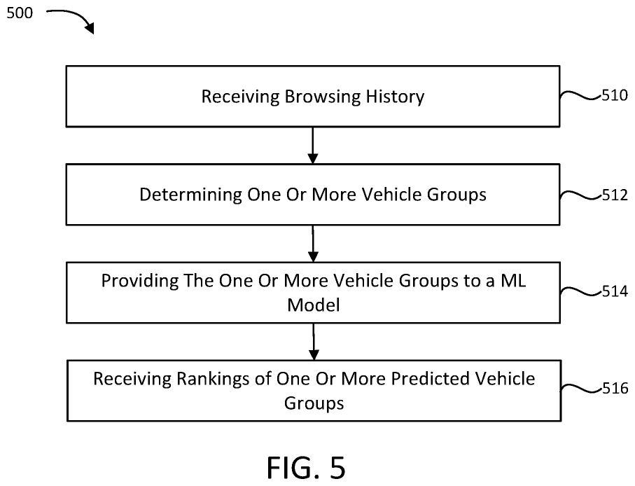

FIG. 5 illustrates an example method 500 for using a model to rank predicted vehicle groups. The method 500 is operable to rank predicted vehicle groups for a user. Some or all of the operations may be performed by the vehicle recommendation system 110 and/or its associated components.

At operation 510, browsing history of a user is received. The browsing history includes vehicle click data of the user. The vehicle click data may be the vehicle click data 126. Further, the vehicle recommendation system 110 may receive the browsing history from the computing device 120. In some embodiments, the vehicle recommendation system 110 receives the vehicle click data from a dealership website, such as the website server 114.

At operation 512, one or more input vehicle groups are determined based on one or more vehicle IDs of the vehicle click data. This operation may include mapping the one or more vehicle IDs to one or more input vehicle groups, which are vehicle group IDs.

At operation 514, the one or more vehicle groups are provided to a ML model. In some embodiments, the model is the ML model 208.

At operation 516, rankings of the one or more predicted vehicle groups based on the similarities of the one or more predicted vehicle groups to the one or more input vehicle groups are received from the ML model. The ML model 208 ranks the one or more predicted vehicle groups. In some embodiments, the similarities are based on vehicle attributes. The similarities are analyzed by calculating a distance between a vector representation of the one or more input vehicle groups and the one or more predicted vehicle groups. In some embodiments, the one or more predicted vehicle groups are ranked based on their probability to be selected by a user.

In some embodiments, the method 500 further includes selecting a vehicle from the predicted vehicle group. In some embodiments, selecting a vehicle is based on the user demographics. In some embodiments, selecting a vehicle is based on dealership data or inventory data. In some embodiments, the method 500 includes providing a recommendation to a device of the user including a recommended vehicle of the first predicted vehicle group. In some embodiments, the method 500 includes determining a second predicted vehicle group of the one or more predicted vehicle groups, the second predicted vehicle group having a rank other than first of the one or more predicted vehicle groups. The second predicted vehicle group may be determined based on an inventory of available vehicles.

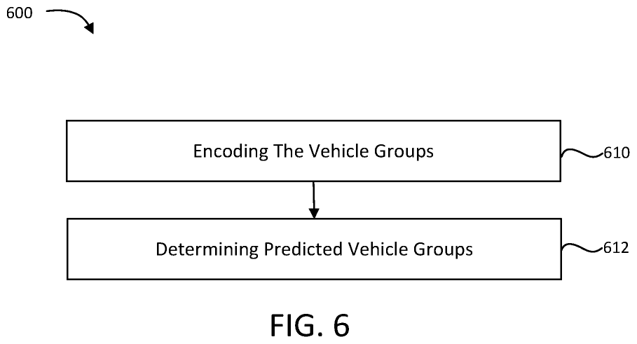

FIG. 6 illustrates an example method 600 that includes additional example operations for the method of FIG. 5. In the shown embodiment, the method 600 processes received vehicle groups as input and determines predicted vehicle groups. Some or all of the operations may be performed by the vehicle recommendation system 110 and/or its associated components. Further, the operations may be performed within or part of the method 500.

At operation 610, the one or more input vehicle groups are encoded into one or more numerical representations. In some embodiments, the ML model 208 encodes the one or more input vehicle groups. Further, the numerical representations are vectors.

At operation 612, the one or more predicted vehicle groups are determined based on a calculated distance between the one or more input vehicle groups and the one or more predicted vehicle groups. In some embodiments, the ML model determines the one or more predicted vehicle groups.

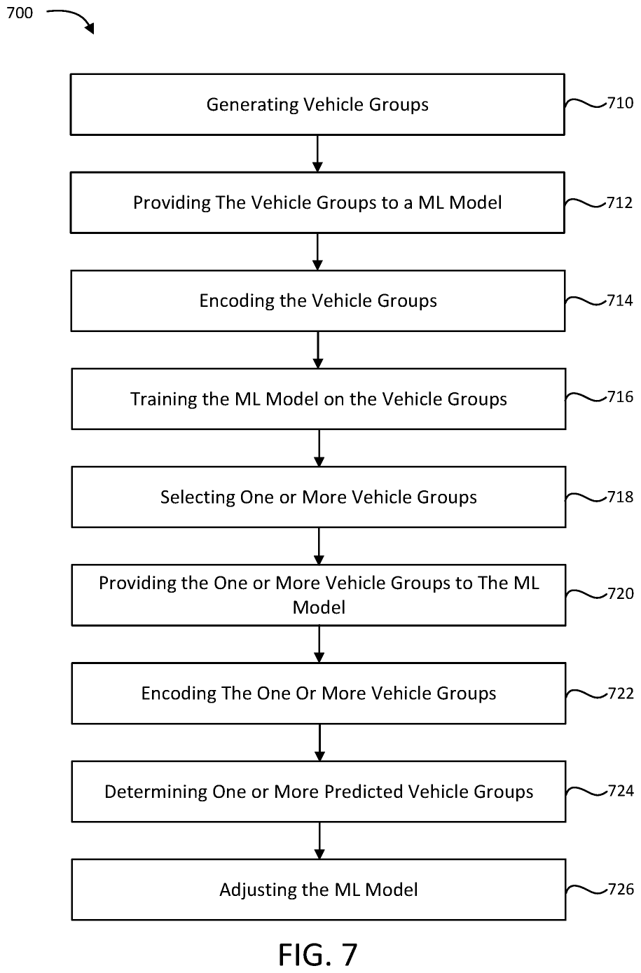

FIG. 7 illustrates an example method for training a model of a vehicle recommendation system. In the shown embodiment, the method 700 is operable to train a ML model to predict vehicle groups. Further, some or all of the shown operations may be performed in conjunction with the method 500 or the method 600. Some or all of the operations may be performed by the vehicle recommendation system 110 and/or its associated components.

At operation 710, one or more vehicle groups are generated. The vehicle groups are vehicle group IDs. In some embodiments, the vehicle recommendation system generates vehicle groups using a model. In other embodiments, the vehicle groups are generated based on predetermined groups.

At operation 712, the one or more vehicle groups are provided to a ML model. In some embodiments, the model is the ML model 208.

At operation 714, the vehicle groups are encoded. In some embodiments, the ML model 208 encodes the vehicle groups. Further, the vehicle groups are encoded into vector representations. The vector representations may include lengths as previously discussed.

At operation 716, The model is trained on the vehicle groups. In some embodiments, this includes predicting vehicle groups that are similar to the input vehicle groups. In some embodiments, the model determines relationships between the vehicle groups based on vehicle attributes. Distances between the vector representations may be calculated and analyzed.

At operation 718, one or more vehicle groups are selected. These vehicle groups may be selected based on user click data. For example, the user may have clicked on several vehicles to view. The browsing history is stored and provided. selecting the one or more vehicle groups may further include mapping the vehicle IDs of the browsing history to the one or more vehicle groups.

At operation 720, the one or more vehicle groups are provided to the ML model. In some embodiments, the model is the ML model 208. Further the ML model may include a bidirectional model for analyzing the one or more vehicle groups.

At operation 722, the one or more vehicle groups are encoded for analysis by the model. In some embodiments, the model calculates a distance between the encoded one or more vehicle groups. In some embodiments, the one or more vehicle groups are encoded into one or more representations. In some embodiments, the ML model 208 encodes the one or more vehicle groups.

At operation 724, one or more predicted vehicle groups are determined. The one or more predicted vehicle groups may be output 326. In some embodiments, the one or more predicted vehicle groups include a probability of how likely the user is to click on a vehicle from the vehicle group or show the vehicle group interest. In some embodiments, the ML model 208 determines the one or more predicted vehicle groups.

At operation 726, the model is adjusted based on the one or more predicted vehicle groups. In some embodiments, adjusting the model includes altering weights affecting the calculation of distances of the vector representations. In some embodiments, the vehicle recommendation system 110 iteratively adjusts weights to alter the calculated distance to meet a predetermined threshold. In some embodiments, the vehicle recommendation system 110 adjusts the ML model 208.

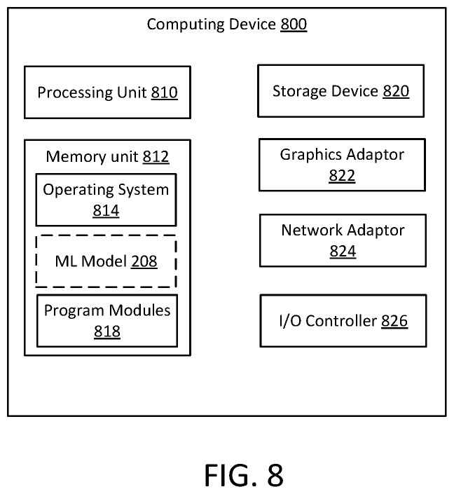

FIG. 8 illustrates an example computing device for performing one or more of the described operations. As shown in FIG. 8, computing device 800 includes a processing unit 810 and a memory unit 812. Memory unit 812 includes an operating system 814 and a program module 818. Optionally, the memory unit 812 includes the ML model 208. The memory unit 812 stores non-transitory instructions for causing the computing device 800 to perform the certain operations, such as the methods 500, 600, or 700. The operating system 812 provides an interface for the program modules to interact with other hardware components of the computing device 800. While executing on processing unit 810, program modules 818 performs, for example, for example, any one or more of the stages from methods 500, 600, or 700 described above with respect to FIGS. 5, 6, and 7, respectively. Computing device 800, for example, provides an operating environment for the vehicle recommendation system 110, website server 114, and the computing device 120. Further, the computing device 800 includes a storage device 820. The storage device 820 may be a non-transitory computer-readable medium including instructions for preforming certain operations. The storage device 820 may be removable or permanently installed. The graphics adaptor is configured to interface with a display device and compute complex calculations for displaying certain data. The graphics adaptor may also be configured to process other data as well. The network adaptor is configured to connect the computing device 800 to a network or other devices. For example, it may connect over Wi-Fi, Bluetooth, ethernet, or other wireless or wired connections. The I/O controller provides an interface for interacting with devise that provide input, such as keyboards, pointing devices, cameras, and the like. Also, the I/O controller interfaces with output devices such as speakers, USB devices, or other output devices. These listed systems and devices may operate in other environments and are not limited to computing device 800.

Computing device 800 can be implemented using a tablet device, a mobile device, a smart phone, a telephone, a remote control device, a personal computer, a network computer, a mainframe, a router, a switch, a server cluster, a smart TV-like device, a network storage device, a network relay device, or other similar microcomputer-based device. Computing device 800 can include any computer operating environment, such as hand-held devices, multiprocessor systems, microprocessor-based or programmable sender electronic devices, minicomputers, mainframe computers, and the like. Computing device 800 can also be practiced in distributed computing environments where tasks are performed by remote processing devices. The aforementioned systems and devices are examples and computing device 800 can comprise other systems or devices.

Embodiments of the disclosure, for example, can be implemented as a computer process (method), a computing system, or as an article of manufacture, such as a computer program product or computer readable media. The computer program product can be a computer storage media readable by a computer system and encoding a computer program of instructions for executing a computer process. The computer program product can also be a propagated signal on a carrier readable by a computing system and encoding a computer program of instructions for executing a computer process. Accordingly, the present disclosure can be embodied in hardware and/or in software (including firmware, resident software, micro-code, etc.). In other words, embodiments of the present disclosure can take the form of a computer program product on a computer-usable or computer-readable storage medium having computer-usable or computer-readable program code embodied in the medium for use by or in connection with an instruction execution system. A computer-usable or computer-readable medium can be any medium that can contain, store, communicate, propagate, or transport the program for use by or in connection with the instruction execution system, apparatus, or device.

The computer-usable or computer-readable medium can be, for example but not limited to, an electronic, magnetic, optical, electromagnetic, infrared, or semiconductor system, apparatus, device, or propagation medium. More specific computer-readable medium examples (a non-exhaustive list), the computer-readable medium can include the following: an electrical connection having one or more wires, a portable computer diskette, a Random Access Memory (RAM), a Read-Only Memory (ROM), an Erasable Programmable Read-Only Memory (EPROM or Flash memory), an optical fiber, a portable Compact Disc Read-Only Memory (CD-ROM), and a portable pen drive. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIGS. 1 and 3 may be integrated onto a single integrated circuit. Such a SOC device may include one or more processing units, graphics unit, communications units, system virtualization units and various application functionality all of which may be integrated (or “burned”) onto the chip substrate as a single integrated circuit. When operating via a SOC, the functionality described herein with respect to embodiments of the disclosure, may be performed via application-specific logic integrated with other components of computing device 800 on the single integrated circuit (chip).

In a first example, a method for recommending vehicle groups includes receiving browsing history of a user. The browsing history includes vehicle click data of the user. The method further includes determining one or more input vehicle groups based on one or more vehicle IDs of the vehicle click data, providing the one or more input vehicle groups to a ML model, and receiving, from the ML model, rankings of one or more predicted vehicle groups based on similarities of the one or more predicted vehicle groups to the one or more input vehicle groups.

In other examples, the method further includes determining a first predicted vehicle group of the one or more predicted vehicle groups. The first predicted vehicle group is ranked first of the one or more predicted vehicle groups. In other examples, the method further includes providing a recommendation to a device of the user including a recommended vehicle of the first predicted vehicle group. In other examples, the method further includes determining a second predicted vehicle group of the one or more predicted vehicle groups. The second predicted vehicle group has a rank other than first of the one or more predicted vehicle groups. In other examples, the first predicted vehicle group is determined based on a distance between a vector representation of the first predicted vehicle group and the one or more input vehicle groups, the distance calculated based on vehicle attributes. In other examples, the method further includes providing a recommendation to a device of the user including a recommended vehicle of the second predicted vehicle group. In other examples, the second predicted vehicle group is determined further based on an inventory of available vehicles. In other examples, vehicles are grouped into the one or more input vehicle groups based on one or more vehicle attributes, the one or more vehicle attributes including one or more of: year, make, vehicle model, fuel type, truck cab, body style, drive train, truck bed size, or doors. In other examples, the ML model is configured to perform: encoding the one or more input vehicle groups into one or more numerical representations, and determining the one or more predicted vehicle groups based on a calculated distance between the one or more input vehicle groups and the one or more predicted vehicle groups.

In a second example, a system for recommending vehicles includes a memory storage, and a processing unit. The processing unit is disposed in a station and coupled to the memory storage. The processing unit is operative to receive browsing history of a user. The browsing history includes vehicle click data of the user. The processing unit is further operative to determine one or more input vehicle groups based on one or more vehicle IDs of the vehicle click data, provide the one or more input vehicle groups to a ML model, and receive rankings from the ML model of one or more predicted vehicle groups based on similarities of the one or more predicted vehicle groups to the one or more input vehicle groups.

In other examples, the processing unit is further operative to determine a first predicted vehicle group of the one or more predicted vehicle groups. The first predicted vehicle group is ranked first of the one or more predicted vehicle groups. In other examples, the processing unit is further operative to provide a recommendation to a device of the user including a recommended vehicle of the first predicted vehicle group. In other examples, the processing unit is further operative to determine a second predicted vehicle group of the one or more predicted vehicle groups. The second predicted vehicle group has a rank other than first of the one or more predicted vehicle groups. In other examples, the first predicted vehicle group is determined based on a distance between a vector representation of the first predicted vehicle group and the one or more input vehicle groups, the distance calculated based on vehicle attributes. In other examples, the processing unit is further operative to provide a recommendation to a device of the user including a recommended vehicle of the second predicted vehicle group. In other examples, the second predicted vehicle group is determined further based on an inventory of available vehicles. In other examples, vehicles are grouped into the one or more input vehicle groups based on one or more vehicle attributes, the one or more vehicle attributes including one or more of: year, make, vehicle model, fuel type, truck cab, body style, drive train, truck bed size, or doors. In other examples, the ML model is configured to encode the one or more input vehicle groups into one or more numerical representations, and determine the one or more predicted vehicle groups based on a calculated distance between the one or more input vehicle groups and the one or more predicted vehicle groups.

In a third example, a non-transitory computer-readable medium stores a set of instructions which when executed perform a method executed by the set of instructions including receiving browsing history of a user. The browsing history includes vehicle click data of the user. The instructions further include determining one or more input vehicle groups based on one or more vehicle IDs of the vehicle click data, providing, by the vehicle recommendation system, the one or more input vehicle groups to a ML model, and receiving, by the vehicle recommendation system from the ML model, rankings of one or more predicted vehicle groups based on similarities of the one or more predicted vehicle groups to the one or more input vehicle groups.

In other examples, the ML model is configured to perform encoding the one or more input vehicle groups into one or more numerical representations, and determining the one or more predicted vehicle groups based on a calculated distance between the one or more input vehicle groups and the one or more predicted vehicle groups.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed:

1. A method for recommending vehicle groups, comprising:
receiving, by a vehicle recommendation system, browsing history of a user, the browsing history including vehicle click data of the user;
determining, by the vehicle recommendation system, one or more input vehicle groups based on one or more vehicle IDs of the vehicle click data;
providing, by the vehicle recommendation system, the one or more input vehicle groups to a machine learning (ML) model; and
receiving, by the vehicle recommendation system from the ML model, rankings of one or more predicted vehicle groups based on similarities of the one or more predicted vehicle groups to the one or more input vehicle groups.

2. The method of claim 1, further comprising determining, by the vehicle recommendation system, a first predicted vehicle group of the one or more predicted vehicle groups, the first predicted vehicle group being ranked first of the one or more predicted vehicle groups.

3. The method of claim 2, further comprising providing, by the vehicle recommendation system, a recommendation to a device of the user including a recommended vehicle of the first predicted vehicle group.

4. The method of claim 2, further comprising determining, by the vehicle recommendation system a second predicted vehicle group of the one or more predicted vehicle groups, the second predicted vehicle group having a rank other than first of the one or more predicted vehicle groups.

5. The method of claim 4, wherein the first predicted vehicle group is determined based on a distance between a vector representation of the first predicted vehicle group and the one or more input vehicle groups, the distance calculated based on vehicle attributes.

6. The method of claim 5, further comprising providing, by the vehicle recommendation system, a recommendation to a device of the user including a recommended vehicle of the second predicted vehicle group.

7. The method of claim 4, wherein the second predicted vehicle group is determined further based on an inventory of available vehicles.

8. The method of claim 1, wherein vehicles are grouped into the one or more input vehicle groups based on one or more vehicle attributes, the one or more vehicle attributes including one or more of:
year;
make;
vehicle model;
fuel type;
truck cab;
body style;
drive train;
truck bed size; or
doors.

9. The method of claim 1, wherein the ML model is configured to perform:
encoding the one or more input vehicle groups into one or more numerical representations; and
determining the one or more predicted vehicle groups based on a calculated distance between the one or more input vehicle groups and the one or more predicted vehicle groups.

10. A system for recommending vehicles, the system comprising:
a memory storage; and
a processing unit, the processing unit disposed in a station and coupled to the memory storage, wherein the processing unit is operative to:
receive browsing history of a user, the browsing history including vehicle click data of the user;
determine one or more input vehicle groups based on one or more vehicle IDs of the vehicle click data;
provide the one or more input vehicle groups to a ML model; and
receive rankings from the ML model of one or more predicted vehicle groups based on similarities of the one or more predicted vehicle groups to the one or more input vehicle groups.

11. The system of claim 10, wherein the processing unit is further operative to determine a first predicted vehicle group of the one or more predicted vehicle groups, the first predicted vehicle group being ranked first of the one or more predicted vehicle groups.

12. The system of claim 11, wherein the processing unit is further operative to provide a recommendation to a device of the user including a recommended vehicle of the first predicted vehicle group.

13. The system of claim 11, wherein the processing unit is further operative to determine a second predicted vehicle group of the one or more predicted vehicle groups, the second predicted vehicle group having a rank other than first of the one or more predicted vehicle groups.

14. The system of claim 13, wherein the second predicted vehicle group is determined based on a distance between a vector representation of the second predicted vehicle group and the first predicted vehicle group, the distance calculated based on vehicle attributes.

15. The system of claim 14, wherein the processing unit is further operative to provide a recommendation to a device of the user including a recommended vehicle of the second predicted vehicle group.

16. The system of claim 15, wherein the second predicted vehicle group determined further based on an inventory of vehicles of a dealership.

17. The system of claim 10, wherein vehicles are grouped into the one or more input vehicle groups based on one or more vehicle attributes, the one or more vehicle attributes including one or more of:
year;
make;
vehicle model;
fuel type;
truck cab;
body style;
drive train;
truck bed size; or
doors.

18. The system of claim 10, wherein the ML model is configured to:
encode the one or more input vehicle groups into one or more numerical representations; and
determine the one or more predicted vehicle groups based on a calculated distance between the one or more input vehicle groups and the one or more predicted vehicle groups.

19. A non-transitory computer-readable medium that stores a set of instructions which when executed perform a method executed by the set of instructions comprising:
receiving, by a vehicle recommendation system, browsing history of a user, the browsing history including vehicle click data of the user;
determining, by the vehicle recommendation system, one or more input vehicle groups based on one or more vehicle IDs of the vehicle click data;
providing, by the vehicle recommendation system, the one or more input vehicle groups to a ML model; and
receiving, by the vehicle recommendation system from the ML model, rankings of one or more predicted vehicle groups based on similarities of the one or more predicted vehicle groups to the one or more input vehicle groups.

20. The non-transitory computer-readable medium of claim 19, wherein the ML model is configured to perform:
encoding the one or more input vehicle groups into one or more numerical representations; and
determining the one or more predicted vehicle groups based on a calculated distance between the one or more input vehicle groups and the one or more predicted vehicle groups.
